(19) United States
(12) Patent Application Publication
(10) Pub. No.: US 2022/0198921 A1
(43) Pub. Date: Jun. 23, 2022

(54) DATA COLLECTION AND MODELING SYSTEMS AND METHODS FOR AUTONOMOUS VEHICLES

(71) Applicant: Sensible 4 Oy, Espoo (FI)

(72) Inventor: Antti Olavi Kangasrääsiö, Espoo (FI)

(73) Assignee: Sensible 4 Oy, Espoo (FI)

(21) Appl. No.: 17/551,091

(22) Filed: Dec. 14, 2021

Related U.S. Application Data
(60) Provisional application No. 63/130,253, filed on Dec. 23, 2020.

(51) Int. Cl. G08G 1/01; G08G 1/0967; G08G 1/04; G08G 1/052; G08G 1/048; G06N 20/00

(52) U.S. Cl. CPC G08G 1/0116; G08G 1/096725; G06N 20/00; G08G 1/052; G08G 1/048; G08G 1/04

(57) ABSTRACT

Embodiments of the disclosed systems and methods provide for systems and methods for collecting and managing vehicle and infrastructure sensor measurement data and building predictive models based on such data. In certain embodiments, operation and/or control of a vehicle may be based on the predictive model. In certain embodiments, the predictive model may be generated and/or otherwise trained based on actual vehicle measurement data and actual infrastructure measurement data that has been correlated by associated time and/or location. In further embodiments, model validation techniques may be used to determine a predictive quality of the model.

### RELATED APPLICATIONS

This application claims benefit of priority under 35 U.S.C. § 119(e) to U.S. Provisional Patent Application No. 63/130,253, filed Dec. 23, 2020, and entitled “DATA COLLECTION AND MODELING SYSTEMS AND METHODS FOR AUTONOMOUS VEHICLES,” which is incorporated herein by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### SUMMARY

The present disclosure relates generally to systems and methods for collecting sensor data and generating predictive models for use in autonomous vehicle (“AV”) operation. More specifically, but not exclusively, the present disclosure relates to systems and methods for collecting and managing vehicle and infrastructure sensor measurement data, building predictive models based on vehicle and infrastructure sensor measurement data, and validating the performance of generated models in connection with AV operations.

Autonomous and/or self-driving and/or semi-autonomous vehicles may generate and/or use a wide variety of sensor and/or measurement data during operation. For example, vehicles may include and/or use light detection and ranging (“LIDAR”) sensors, radio detection and ranging (“RADAR”) sensors, vision and/or visibility sensors (e.g., cameras), weather and/or other environmental sensors, and/or the like. These sensors may provide a variety of information relating to an AV and/or its surrounding environment that may be used in connection with a number of operational contexts and/or control decisions.

Certain types of sensor systems may not be readily integrated into a vehicle platform due to economic, physical, and/or otherwise practical constraints. For example, larger weather and/or visibility sensing systems may prove difficult to integrate directly into a vehicle platform due to their physical size and/or weight.

Roadside and/or infrastructure sensor systems, which may be collectively referred to herein as infrastructure sensor systems and/or derivatives thereof, may be placed along roads and/or other pathways traversed by vehicles. Information generated by infrastructure sensor systems may be provided to vehicles within the communication range of the sensor systems via local communication channels and/or to cloud and/or edge cloud services associated with the vehicle via one or more network connections. Infrastructure sensor systems may provide a variety of information relating to an AV and/or its surrounding environment. For example and without limitation, infrastructure sensor systems may provide information relating to meteorological visibility in an environment surrounding a vehicle, which may be useful for object detection, localization, mapping, and/or other processes associated with safe vehicle operation.

In some instances, infrastructure sensor systems may comprise systems that may be more challenging to integrate into a vehicle platform due to economic, physical, and/or otherwise practical constraints. In other circumstances, infrastructure sensor systems may comprise types of sensors that may also be integrated into a vehicle platform, but may be more accurate, reliable, calibratable, and/or otherwise easier to validate than similar vehicle-based sensor systems. Similar sensors as those installed in vehicles may also be installed within roadside infrastructure, offering a degree of redundancy).

Infrastructure measurement devices may not be available in all locations and/or may not provide information in certain areas and/or locations along a pathway traversed by a vehicle. For example, there may be a number of locations a vehicle may be operated where the distance to the nearest infrastructure sensor system exceeds a data collection range of the system and/or does not allow for collection of measurement data that provides a reliable estimate of conditions associated with a vehicle. Similarly, topological features (e.g., mountains, valleys, and/or the like) may impact and/or otherwise limit the effective range of infrastructure sensor systems. Occasionally the infrastructure sensors may also be out of operation, limiting their availability.

Embodiments disclosed herein provide for systems and methods for collecting and managing vehicle and infrastructure sensor measurement data and building predictive models based on such data. In various embodiments, operation and/or control of the AV may be based, at least in part, on the predictive model. For example, in some embodiments, predictive modeling techniques may be used to identify predicted roadside measurement data based on a trained model. In certain embodiments, the predictive model may be generated and/or otherwise trained based on actual vehicle measurement data and actual infrastructure measurement data that has been correlated by associated time and/or location. In further embodiments, model validation techniques may be used to determine a predictive quality of the model. Alerts may be generated and/or operational processes reliant on the predictive model may be adjusted based on the results of model validation processes.

### BRIEF DESCRIPTION OF THE DRAWINGS

The inventive body of work will be readily understood by referring to the following detailed description in conjunction with the accompanying drawings, in which:

FIG. 1 illustrates a non-limiting example of a high-level architecture for collecting sensor measurement data and building a predictive model based on collected sensor data consistent with certain embodiments of the present disclosure.

FIG. 2 illustrates a non-limiting simplified example of vehicle sensor measurement data signals and an infrastructure sensor measurement data signal consistent with certain embodiments of the present disclosure.

FIG. 3 illustrates a non-limiting example of predictive data modeling processes consistent with certain embodiments of the present disclosure.

FIG. 4 illustrates a non-limiting example of predictive correlation between vehicle sensor measurement data signals and an infrastructure sensor measurement data signal consistent with certain embodiments of the present disclosure.

FIG. 5 illustrates a non-limiting example of relationships between a collected infrastructure sensor measurement signal, a predicted infrastructure sensor measurement signal, a prediction quality indication, and collected vehicle sensor measurement data signals consistent with certain embodiments of the present disclosure.

FIG. 6 illustrates a non-limiting example of predictive data model validation processes consistent with certain embodiments of the present disclosure.

FIG. 7 illustrates a non-limiting example of determining a data collection range of an infrastructure sensor system consistent with certain embodiments of the present disclosure.

FIG. 8 illustrates a flow chart of a non-limiting example of a method of operating a vehicle using a trained model consistent with certain aspects of the disclosed embodiments.

FIG. 9 illustrates a flow chart of a non-limiting example of a method of validating a trained model consistent with certain aspects of the disclosed embodiments.

FIG. 10 illustrates an example of a system that may be used to implement certain embodiments of the systems and methods of the present disclosure.

### DETAILED DESCRIPTION

A description of the systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, wherein like parts may in some instances be designated by like numbers and/or descriptions. The components of the disclosed embodiments, as generally described and/or illustrated in the figures herein, could be arranged and designed in a wide variety of different configurations. Thus, the following description of the embodiments of the systems and methods of the disclosure is not intended to limit the scope of the disclosure, but is merely representative of possible embodiments of the disclosure. In addition, the steps of any method disclosed herein do not necessarily need to be executed in any specific order, or even sequentially, nor need the steps be executed only once, unless otherwise specified.

Embodiments of the disclosed systems and methods provide techniques for building models based on vehicle and infrastructure sensor measurement data that may be used to predict information regarding a vehicle and/or its surrounding environment based on available data. Models consistent with certain embodiment disclosed herein may be used in connection with various aspects of vehicle operation and/or control.

Consistent with embodiments disclosed herein, vehicle sensor measurement data and infrastructure sensor measurement data may be collected and correlated in time and/or by location to identify interrelationships that may be reflected in a predictive model. When actual infrastructure sensor measure data is not available, available vehicle sensor measurement data and the predictive model may be used to estimate and/or otherwise predict associated infrastructure measurement data. Various embodiments further provide for model validation techniques to determine a predictive quality of the model when actual infrastructure sensor measurement data is available and can be compared with predicted infrastructure sensor measurement data generated by the model. Appropriate actions may then be taken based on the determined predictive quality.

Although various embodiments are generally described herein as being used in connection with AVs for purposes of illustration and explanation, it will be appreciated that the described embodiments of the disclosed systems and methods may be used in connection with fully autonomous, semi-autonomous, and/or other assisted driving vehicles (e.g., assisted driving vehicles driven at least in part by an in-vehicle driver and/or a remote operator). Moreover, it will be appreciated that various aspects of the disclosed embodiments may be used in connection with a variety of types of vehicles including, for example and without limitation, passenger vehicles, transit vehicles, freight vehicles, land-based vehicles, watercraft, aircraft, and/or the like.

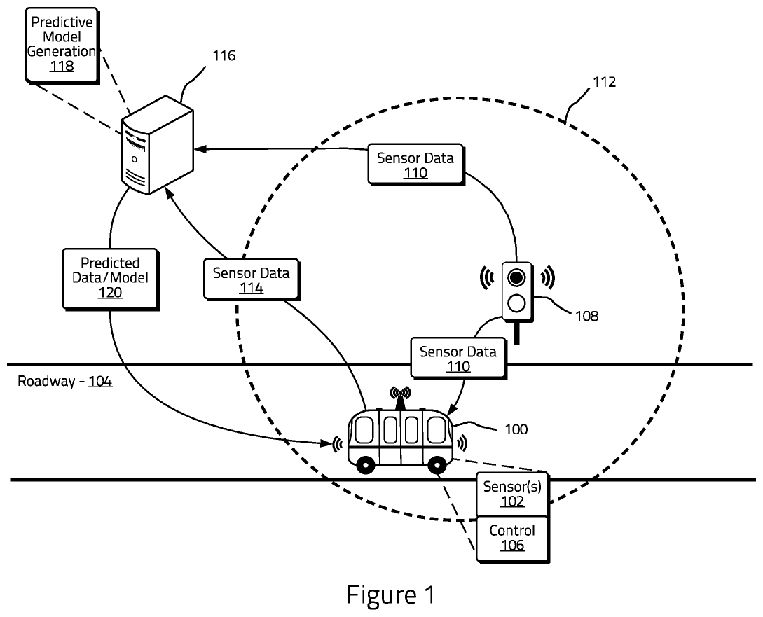

FIG. 1 illustrates a non-limiting example of a high-level architecture for collecting sensor measurement data and building a predictive model based on collected sensor data consistent with certain embodiments of the present disclosure. An AV 100 may include one or more sensors 102 configured to generate and/or otherwise provide various data associated with the AV 100 and/or its surrounding environment (e.g., information relating to a roadway 104). A variety of sensors 102 may be used in connection with various embodiments disclosed herein. For example and without limitation, an AV 100 may comprise one or more GPS systems and/or other location sensors, vehicle speed sensors (“VSSs”), accelerometers, light detection and ranging (“LIDAR”) sensors, cameras and/or other visual sensors, radio detection and ranging (“RADAR”) sensors, weather and environmental sensors, odometers, kinematic sensors, and/or any other type of sensor that may be included in a vehicle.

Information received from such sensor systems 102 may provide vehicle control systems 106 with contextual information relating to an environment around an AV including, for example and without limitation, object identification and/or detection information (e.g., obstacles, other vehicles, pedestrians, and/or the like), road condition (e.g., estimates of friction conditions, presence of water on the road, etc.) and/or lane information, weather and/or other environmental information, and/or the like, and may be collectively referred to herein as vehicle sensor measurement data and/or derivatives thereof. As discussed below, vehicle sensor measurement data may be reflected in one or more vehicle sensor measurement data signals provided by associated vehicle sensors.

Infrastructure sensor systems 108 may be placed along roads and/or other pathways and/or areas traversed by vehicles in one or more fixed and/or variable locations (e.g., roadway 104). Infrastructure sensor systems 108 may comprise, for example and without limitation, speed and/or vehicle movement and/or ranging sensors, LIDAR sensors, cameras and/or other vision sensors, RADAR sensors, weather and environmental sensors, and/or any other type of sensor that may provide information relating to a vehicle, its surrounding environment, and/or a roadway and/or pathway traversed by the vehicle.

In at least one non-limiting example, infrastructure sensor systems 108 may provide information relating to meteorological visibility in an environment surrounding a vehicle 100, which may be useful for object detection, localization, mapping, and/or other processes associated with safe vehicle operation. In another non-limiting example, infrastructure sensor systems may provide information relating to the road surface conditions on a road segment 104 travelled by the vehicle, which may be useful in planning vehicle routing, choosing an appropriate driving speed, adjusting vehicle maneuvering system parameters and/or other vehicle control process parameters, and/or the like.

In various embodiments, infrastructure sensor systems 108 may comprise sensor platforms that may not be readily integrated into a vehicle platform due to economic, physical, and/or otherwise practical constraints. In further embodiments, infrastructure sensor systems 108 may comprise types of sensors that may also be integrated into a vehicle platform, but may be more accurate, reliable, calibratable, and/or otherwise easier to validate than similar vehicle-based sensor systems. As discussed below, infrastructure sensor measurement data may be reflected in one or more infrastructure sensor measurement data signals 110 provided by associated infrastructure sensors 108.

Infrastructure sensor systems 108 may be associated with a data collection range 112. The data collection range 112 of an infrastructure sensor system 108 may be determined using a variety of methods and/or based on a variety of factors. In some embodiments, the data collection range 112 of an infrastructure sensor 108 may comprise a set and/or otherwise fixed range (e.g., a fixed distance from a location of an infrastructure sensor system 108) defining a range and/or distance at which the sensor platform 108 can reliably produce measurement data. In certain instances, this range 112 may be set by a sensor manufacturer based on known and/or otherwise characterized detection capabilities and/or sensitivity of a sensor platform 108. In further embodiments, the data collection range 112 of an infrastructure sensor system108 may comprise a bounded and/or otherwise geofenced area surrounding the infrastructure sensor 108 that may be defined by any suitable technique and/or by one or more entities associated with the sensor platform 108 (e.g., an infrastructure sensor operator and/or the like).

In further embodiments, the data collection range 112 of an infrastructure sensor system 108 may be dynamic in nature. In some embodiments, the data collection range 112 of an infrastructure sensor 108 may vary based on contextual information relating to an environment surrounding the sensor 108 that may impact the effective detection and/or sensitivity capabilities of the sensor platform 108. For example and without limitation, under certain weather conditions (e.g., fog) and/or low lighting conditions (e.g., during nighttime), a vision sensor may have more limited detection capabilities and/or accuracy than when operating under different conditions (e.g., clear skies and/or during daytime). Accordingly, the effective data collection range 112 of the vision sensor may be adjusted to account for the different operating conditions.

In some embodiments, the data collection range 112 of an infrastructure sensor 108 may be associated with and/or otherwise defined by a communication range between the infrastructure sensor system 108 and an AV 100. That is, in some implementations, the data collection range 112 of an infrastructure sensor system 108 may correspond to a range at which the sensor system 108 is capable of communicating with an AV 100 and/or an associated system.

Certain conditions, such as weather and/or other environmental conditions, may vary over a region and may change relatively quickly as an AV 100 progresses along a route. To account for this consideration, in some embodiments, the data collection range 112 of an infrastructure sensor system 108 may be varied and/or otherwise selected to provide a sufficiently good estimate of conditions around a vehicle 100. For example, as temperature is a measurement that often doesn't vary particularly quickly over time and/or across a localized area, a larger data collection radius 112 may be used. Visibility, however, may vary more between different locations, and thus a smaller data collection range 112 may be used for visibility measurements.

As illustrated, vehicle sensor measurement data 114 may be communicated from the AV 100 to one or more cloud processing services 116. In further embodiments, vehicle sensor measurement data 114 may alternatively and/or additionally be shared with one or more other services and/or platforms, including network edge services and/or infrastructure sensor systems 108.

Infrastructure sensor measurement data 110 may be communicated from an infrastructure sensor system 108 to the AV 100 and/or the cloud processing service(s) 116. Although not specifically illustrated, in some embodiments, the infrastructure sensor system 108 may further communicate sensor measurement data 110 to one or more other cloud services and/or network edge services, which may be associated with the infrastructure sensor system 108 and/or remote system(s)

In various embodiments, one or more systems, services, and/or vehicles may act as data communication intermediaries. For example and without limitation, in some embodiments, infrastructure sensor measurement data 110 may be communicated from the infrastructure sensor system 108 to the AV 100 which in turn may communicate the received infrastructure sensor measurement data 110 to the cloud processing service 116. In some embodiments, the AV 100 may communicate such infrastructure sensor measurement data 110 with vehicle sensor measurement data 114. In further embodiments, the AV 100 may communicate the infrastructure sensor measurement data 110 separately from vehicle sensor measurement data 114.

The AV 100 and/or associated systems and/or services (e.g., the cloud service 116, the infrastructure sensor system 108, and/or the like) may communicate using a variety of suitable network connections implementing a variety of suitable communication technologies, channels, standards, and/or protocols. For example and without limitation, the AV 100 and/or associated systems and/or services may communicate using LTE wireless network standards and/or protocols, 5G wireless network standards and/or protocols, and/or the like. In some implementations, certain systems and/or services may communicate using a variety of suitable wired communication technologies, channels, standards, and/or protocols.

Consistent with various disclosed embodiments and as detailed below, an AV system 100, cloud service 116, and/or network edge service may use collected vehicle sensor measurement data 114 and infrastructure sensor measurement data 110 to identify interrelationships and build an associated predictive model. Various examples disclosed herein describe a cloud service 116 and/or an associated predictive model generation engine 118 generating predictive models and/or associated information based on available sensor measurement data 114, 110. It will be appreciated, however, that in further examples, predictive modeling and/or associated techniques may be performed by the AV 100 and/or associated systems, systems and/or processing capabilities associated with an infrastructure sensor system 108, and/or network edge processing services (which may be associated with the infrastructure sensor system 108 and/or be a separate system and/or service).

Collected vehicle and infrastructure sensor measurement data 110, 114 may be correlated in time and/or by location by a predictive model generation engine 118. Correlative and/or otherwise predictive relationships between the collected vehicle and infrastructure sensor measurement data 110, 114 may be identified and modeled. In some embodiments, available vehicle sensor measurement data 114 and the predictive model may be used to estimate and/or otherwise predict associated infrastructure measurement data when actual infrastructure sensor measurement data 110 is not available (e.g., when an AV 100 is outside a data collection range 112 of the infrastructure sensor system 108). In further embodiments, as described in more detail below, available vehicle sensor measurement data 114 and the predictive model may be used in connection with available infrastructure sensor measurement data 110 to evaluate and/or otherwise validate the predictive accuracy of the model.

In some embodiments, the model and/or associated predicted data 120 may be communicated from the cloud service 116 (and/or network edge processing services) to the AV 100. For example and without limitation, in certain implementations, the predictive model 120 may be communicated to the AV 100 and/or associated systems, which may use the predictive model 120 to locally generate predicted infrastructure measurement data based on available vehicle sensor measurement data 114 and use the predicted data in connection with control decisions implemented by one or more control systems 106. In further embodiments, rather than communicating the predictive model to the AV 100 for local use, in some embodiments the cloud service 116 and/or network edge processing services may engage in predictive modeling techniques (e.g., based on available vehicle sensor measurement data 114 communicated to the cloud service 116 and/or network edge processing services), and communicate the associated predicted data 120 (e.g., predicted infrastructure sensor measurement data) to the AV 100 for use in connection with control decisions implemented by one or more control systems 106.

In various embodiments, the predictive model may be continuously updated when new sensor measurement data is available, thereby improving the accuracy of the model over time. For example, in certain embodiments, whenever a vehicle 100 is within a data collection range 112 of an infrastructure sensor system 108, new vehicle sensor measurement data and infrastructure measurement data may be collected and used as additional data to refine the predictive model (e.g., refined by a cloud service 116, network edge services, and/or the vehicle 100). For example, the predictive model may be generated and/or otherwise refined by an associated cloud service 116 based on collected vehicle sensor measurement data and infrastructure sensor measurement data communicated to the service 116. Generated and/or refined predictive models, which may be used by the cloud service 116 and/or directly by local vehicle systems, may then be updated (e.g., updated periodically from the cloud service 116 and/or upon the occurrence of some other event such as a maintenance update and/or the like). In further embodiments, and as described in more detail below, model validation techniques may be employed to determine a predictive quality of the model. In some embodiments, the predictive quality of the model may be evaluated and/or otherwise validated by a cloud service 116 and/or the vehicle 100, either simultaneously or immediately following the data collection, and/or at a later time.

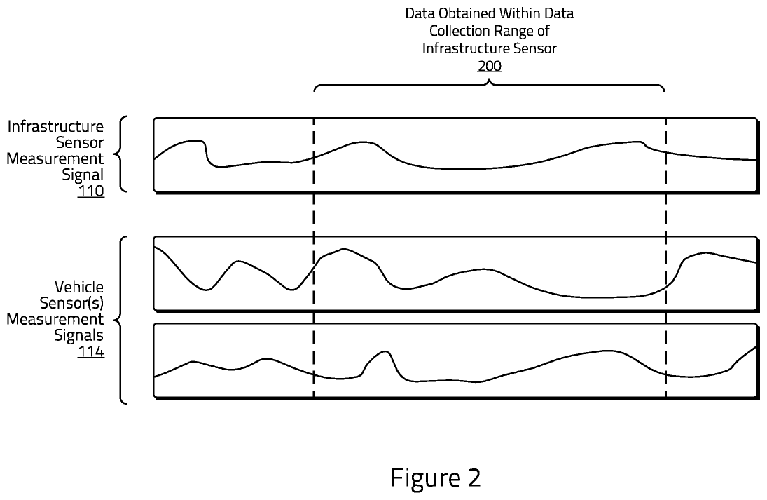

FIG. 2 illustrates a non-limiting example of vehicle sensor measurement data signals 114 and an infrastructure sensor measurement data signal 110 consistent with certain embodiments of the present disclosure. In the illustrated example, the horizontal axis represents time and the vertical axis represents signal levels. As shown, one or more vehicle sensor measurement data signals 114 may be collected from one or more vehicle sensor systems. In addition, one or more infrastructure sensor measurement data signals 110 may be collected from one or more infrastructure sensor systems.

Although two vehicle sensor measurement data signals 114 and one infrastructure sensor measurement data signal 110 are shown for purposes of explanation in the examples of FIG. 2 and elsewhere herein, it will be appreciated that various aspects of the disclosed systems and methods may be employed in connection with any suitable number of vehicle sensor measurement data signals and/or infrastructure sensor measurement data signals. Moreover, it will be appreciated that the measurement data signals 110, 114 may be higher dimensional than that depicted in FIG. 2 (e.g., as may be the case in camera, LIDAR, RADAR measurement data, and/or other measurement data structures or time series, such as, for example and without limitation, diagnostics and/or logging and/or software internal state related data).

The collected vehicle sensor measurement data signals 114 and infrastructure sensor measurement data signals 110 may be time and/or location correlated. Signals 200 collected in a time period and/or locations where the vehicle was within the data collection range of the infrastructure sensor system may be identified. The correlated data signals collected when the vehicle was within the data collection range of the infrastructure sensor system 200 may be analyzed to identify interrelationships that may be reflected in a predictive model. For example, consistent with various disclosed embodiments, a model may be built which predicts an infrastructure sensor measurement signal based on one or more actual input vehicle sensor measurement signals 114.

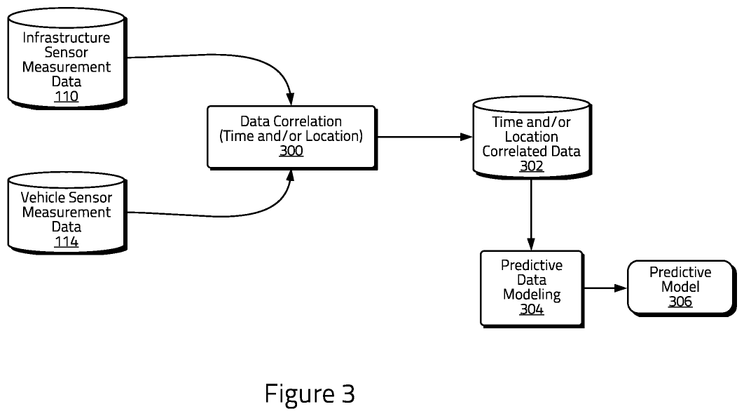

FIG. 3 illustrates a non-limiting example of predictive data modeling processes consistent with certain embodiments of the present disclosure. Various aspects of the illustrated process may be performed and/or otherwise implemented by one or more systems associated with a vehicle, an infrastructure sensor system, cloud services, and/or any suitable combination thereof. For example, various aspects of the illustrated process may be performed by a predictive model generation engine executing on a cloud service, an AV, edge cloud services, and/or any associated service and/or services.

Infrastructure sensor measurement data 110 and vehicle sensor measurement data 114 may be aggregated and/or otherwise collected. The infrastructure sensor measurement data 110 and vehicle sensor measurement data 114 may be correlated by a data correlation block 300 based on time and/or location to generate a correlated data set 302. Consistent with various disclosed embodiments, data in the correlated data set 302 may comprise data obtained when the vehicle was within the data collection range of an infrastructure system. The correlated data set 302 may be provided to a predictive modeling block 304 (e.g., a predictive modeling component of a predictive model generation engine).

The predictive modeling block 304 may analyze and/or otherwise identify relationships between relevant correlated vehicle and infrastructure sensor measurement data in the correlated data set 302 and generate a predictive model 306. Consistent with embodiments disclosed herein, the generated predictive model 306 may provide a predicted infrastructure sensor measurement data signal based on one or more actual vehicle sensor measurement data signals, providing an estimate of a likely infrastructure sensor measurement data signal when an actual signal from an infrastructure sensor system is not available (e.g., when the vehicle is outside a range of an infrastructure sensor system). In various embodiments, the predicted infrastructure sensor measurement data signal may comprise a single value, a confidence interval over possible values, a probability distribution over possible values, and/or other similar statistical predictions and/or combinations thereof.

The predictive modeling block 304 may use a variety of modeling techniques to generate a predictive model 306 reflecting relationships between one or more vehicle sensor measurement data signals 110 and one or more infrastructure sensor measurement data signals 114. For example and without limitation, techniques used to generate a predictive model may comprise one or more of regression modeling, neural network modeling, probabilistic modeling, fuzzy logic modeling, lookup table modeling, nearest-neighbor methods, decision tree modeling, dynamic system modeling, time-series modeling, recurrent modeling, frequency-domain modeling, autoregressive modeling, moving average modeling, any/or any other suitable technique or combination of techniques for generating a predictive model. In at least one further non-limiting example, prediction model training may involve estimating gradients and adjusting parameters of a prediction model relative to a prediction loss function using collected data consistent with various embodiments disclosed herein.

It will be appreciated that a variety of techniques may be employed to model relationships between data in the correlated data set 302 that may be used to generate predicted infrastructure sensor measurement data signals based on available vehicle sensor measurement data signals, and that any suitable predictive modeling and/or model training techniques may be employed in connection with various aspects of the disclosed embodiments.

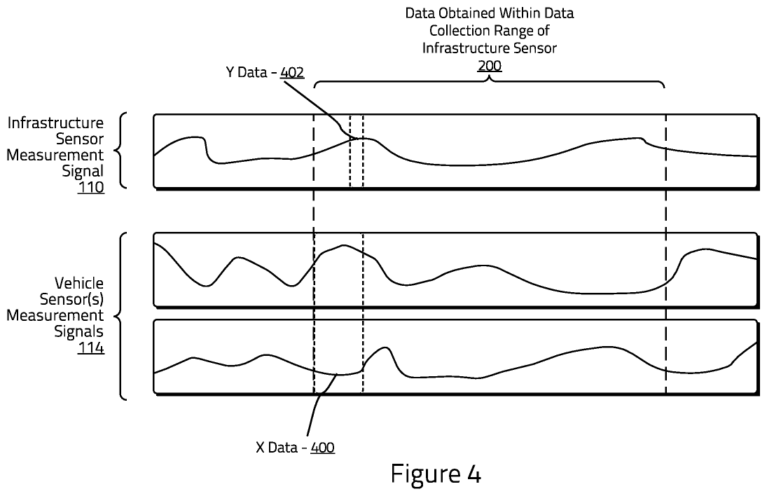

FIG. 4 illustrates a non-limiting example of predictive correlation between vehicle sensor measurement data signals 114 and an infrastructure sensor measurement data signal 110 consistent with certain embodiments of the present disclosure. In the illustrated example, the horizontal axis represents time and the vertical axis represents signal levels. As shown, one or more vehicle sensor measurement data signals 114 may be collected from one or more vehicle sensor systems. In addition, one or more infrastructure sensor measurement data signals 110 may be collected from one or more infrastructure sensor systems.

The collected vehicle sensor measurement data signals 114 and infrastructure sensor measurement data signals 110 may be time and/or location correlated. Signals 200 collected in a time period and/or locations where the vehicle was within the data collection range of the infrastructure sensor system may be identified. Consistent with various aspects of the disclosed embodiments, the time and/or location correlated infrastructure sensor measurement data signal(s) and vehicle sensor measurement data signal(s) 200 may be analyzed to identify correlative relationships between the signals.

For example and without limitation, in FIG. 4, the vehicle sensor measurement data signals labeled “X Data” 400 may be used as independent variables and infrastructure sensor measurement data signals labeled “Y Data” 402 may be used as a dependent variable in building a model for predicting infrastructure sensor measurement data based on available vehicle sensor measurement data.

In various embodiments, the generated model may be used to predict real-time and/or current predicted infrastructure sensor measurement data based on available vehicle sensor measurement data (e.g., data signals 114). In further embodiments, the generated model may be used to identify predicted future infrastructure sensor measurement data based on current available vehicle sensor measurement data. Further embodiments may use the generated model to identify past infrastructure sensor measurement data based on associated available vehicle sensor measurement data.

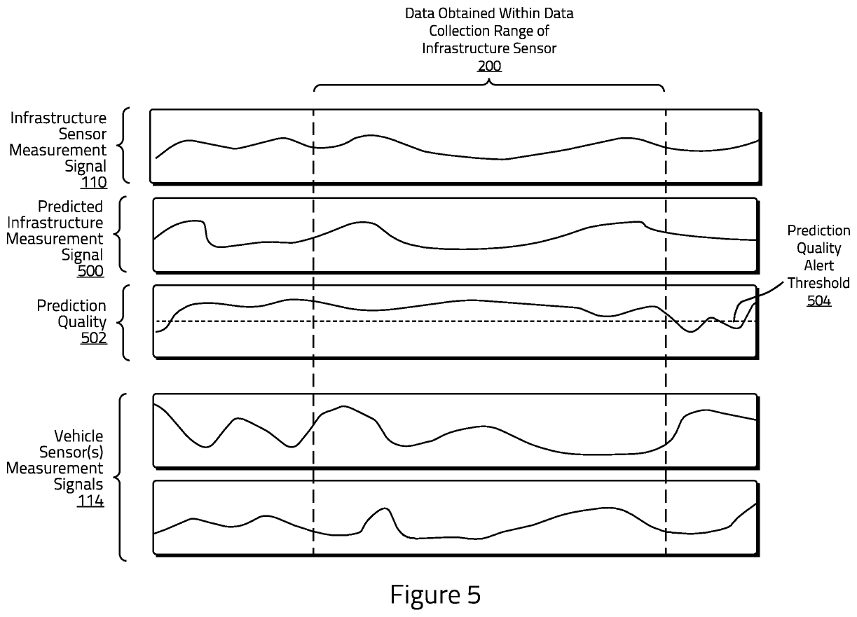

FIG. 5 illustrates a non-limiting example of relationships between a collected infrastructure sensor measurement signal 110, a predicted infrastructure sensor measurement signal 500, a prediction quality indication 502, and collected vehicle sensor measurement data signals 114 consistent with certain embodiments of the present disclosure. In the illustrated example, the horizontal axis represents time and the vertical axis represents signal levels. As shown, one or more vehicle sensor measurement data signals 114 may be collected from one or more vehicle sensor systems. In addition, one or more infrastructure sensor measurement data signals 110 may be collected from one or more infrastructure sensor systems.

The collected vehicle sensor measurement data signals 114 and infrastructure sensor measurement data signals 110 may be time and/or location correlated, and signals 200 collected in a time period and/or locations where the vehicle was within the data collection range of the infrastructure sensor system may be identified. The correlated data signals 200 collected when the vehicle was within the data collection range of the infrastructure sensor system may be analyzed to identify interrelationships and a predictive model may be built that generates a predicted infrastructure sensor measurement data signal 500 based on one or more input vehicle sensor measurement signals (e.g., signals 114).

The predicted infrastructure sensor measurement data signal 500 may be used in a variety of control actions and/or processes associated with operation of the AV when actual infrastructure sensor measurement data (e.g., signal 110) is not available (e.g., when the AV is outside the data collection range of an infrastructure sensor system). For example and without limitation, one or more predicted infrastructure sensor measurement data signals 500 generated using the predictive model based on available vehicle sensor measurement signals 114 may provide information relating to meteorological visibility in an environment surrounding a vehicle, which may be useful for object detection, localization, mapping, and/or other processes associated with safe vehicle operation. In further non-limiting examples, one or more predicted infrastructure sensor measurement data signals 500 generated using the predictive model based on available vehicle sensor measurement signals 114 may provide information relating to the current road conditions in an environment surrounding a vehicle, which may be useful for vehicle maneuver planning and/or vehicle control, and/or other processes associated with safe vehicle operation.

Various disclosed embodiments further provide for model validation techniques to determine a predictive quality of the model when actual infrastructure sensor measurement data (e.g., signal 110) is available and can be compared with predicted infrastructure sensor measurement data 500 generated by the model. For example, as illustrated, a prediction quality indication 502 may be determined that varies based on how well predicted infrastructure sensor measurement data signals 500 generated by the model track actual infrastructure measurement data signals 110 when they are available. The prediction quality indication 502 may be compared with one or more thresholds 504, which may comprise one or more fixed and/or a contextually dynamic thresholds (e.g., thresholds based on vehicle speed, proximity to other objects, location, and/or the like), and alerts may be generated and/or operational processes reliant on the predictive model may be adjusted based on a comparison between the prediction quality indication 502 and the one or more thresholds 504.

A prediction quality indication 502 consistent with various disclosed embodiments may be determined and/or otherwise calculated using a variety of suitable techniques. For example, as noted above, a prediction quality indication 502 may be generated by comparing an actual infrastructure sensor measurement data signals 110 when they are available with corresponding predicted infrastructure measurement data signals 502 generated by the predictive model to identify a relative predictive accuracy of the model. A variety of comparison functions and/or techniques may be employed including, for example and without limitation, a mean absolute error determination between the actual infrastructure sensor measurement data and the predicted infrastructure measurement data signal. In further embodiments, other comparison functions and/or techniques may be employed, including, for example and without limitation, mean squared error techniques, root mean squared error techniques, Huber loss techniques, cross entropy techniques, signal correlation based techniques, mutual information based techniques, Kullback-Leibler divergence techniques, Wasserstein distance techniques, and/or any other function and/or technique for determining model prediction quality and/or combinations thereof.

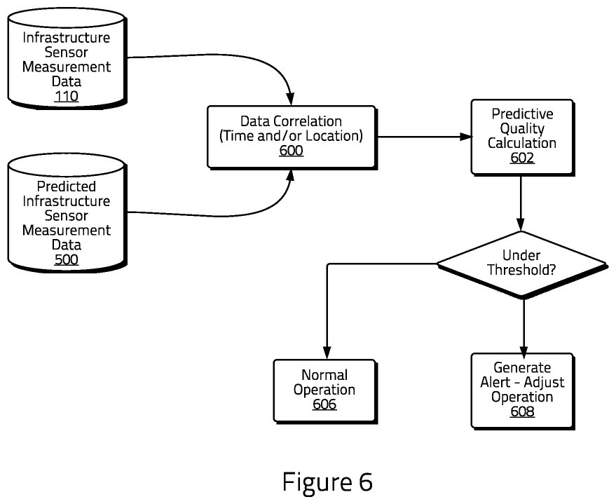

FIG. 6 illustrates a non-limiting example of predictive data model validation process consistent with certain embodiments of the present disclosure. Various aspects of the illustrated process may be performed and/or otherwise implemented by one or more systems associated with a vehicle, an infrastructure sensor system, cloud services, and/or any suitable combination thereof. For example, various aspects of the illustrated process may be performed by a predictive model generation engine executing on a cloud service, an AV, edge cloud services, and/or any associated service and/or services.

As illustrated, available actual infrastructure sensor measurement data 110 and predicted infrastructure sensor measurement data 500 generated by a prediction model trained consistent with various aspects of the disclosed embodiments may be obtained and/or generated. The data 110, 500 may be time and/or location correlated by a data correlation block 600, and data 110, 500 collected and/or predicted within a period when the vehicle is within the data collection range of an associated infrastructure sensor may be identified.

The available actual infrastructure sensor measurement data can be compared with predicted infrastructure sensor measurement data generated by the model, and an associated prediction quality indication may be calculated based on the comparison by a calculation block 602. For example, a prediction quality indication may be calculated that varies based on how well predicted infrastructure sensor measurement data signals 500 generated by the model track and/or otherwise follow actually obtained infrastructure measurement data signals 110.

A variety of prediction quality indications and/or metrics may be used in connection with various disclosed embodiments. For example, a prediction quality indication may provide an indication of an average prediction error over a set of test data, a squared error, and/or a similar mathematically comparative prediction quality metric.

The prediction quality indication may be compared with one or more thresholds, which may comprise one or more fixed and/or a contextually dynamic thresholds, and alerts may be generated and/or operational processes reliant on the predictive model may be adjusted based on the comparison between the prediction quality indication and the one or more thresholds. For example, as illustrated in FIG. 6, if a prediction quality indication is below a threshold, an alert may be generated 608 that may be provided to an operator and/or passenger of the vehicle and/or a system that may use predicted signal data (e.g., an in vehicle and/or remote operator—which may be a remote vehicle operator and/or a fleet manager and/or system operator—and/or passenger). The alert may comprise, for example and without limitation, a notification shown to an operator on screen, a log line written to a log file, and/or any other alert that may provide awareness of the relative prediction quality of the predictive model.

Similarly, an operational process of the vehicle that uses the predictive model may be adjusted 608 such that the process does not rely on the predictive model and/or weighs information generated by the predictive model less than if the predictive quality of the model was higher. If the prediction quality indication is not below the threshold, normal vehicle operation and reliance on the predictive model may continue 606.

Consistent with various embodiments disclosed herein, measurement data may be collected, processed, and/or analyzed using an online system, where data is collected during driving from both the AV and infrastructure measurement devices. In further embodiments an offline system may be employed, where previously collected data is processed into datasets and analyzed consistent with various aspects of the disclosed systems and methods.

In various embodiments, the prediction quality of the predictive model may be monitored via a continuous process online when the vehicle is operating and/or via a process that is run regularly (e.g., periodically) post-hoc on previously recorded data. In certain embodiments, the same performance metric may be used to evaluate the prediction quality of the model that was used to train the model based on actual recorded vehicle sensor measurement data and infrastructure sensor measurement data. In further embodiments, a different performance metric may be used for training the model than that used for later validation and/or prediction quality indication determinations.

As discussed above, certain aspects of the disclosed systems and methods may be performed using a vehicle computer system and/or via one or more other systems and/or services (and/or combinations thereof). For example, certain aspects of the disclosed systems and methods may be performed using systems associated with an infrastructure sensor system and/or cloud service (e.g., systems associated with a remote AV command center and/or the like).

A variety of location information may be used in connection with various aspects of disclosed embodiments and may be determined using a variety of techniques. For example, a location of an infrastructure sensor system may be a known location marked by latitude and/or longitude information in a map database and/or may be a manually estimated location. A location of the AV can be determined by using a location estimate of the vehicle provided by a position and/or location determination system (e.g., a GPS system and/or the like) and/or by estimating the location post-hoc from data using any suitable algorithm for position estimation.

In some embodiments, an AV's location may be determined using a probability distribution of estimated vehicle positions. For example, a mean of a distribution of estimated positions may be used as the location of the vehicle. In another example, other point estimates that can be derived from the distribution may be used in connection with aspects of the disclosed embodiments.

A distance between an AV and an infrastructure measurement system may be estimated, for example and without limitation, using a Euclidean distance formula. Other types of distance measurements and/or determinations, which may be used in connection with establishing data collection ranges, may also be employed including, for example and without limitation, measurements that take into account a manner in which measured qualities propagate in an environment. For example, certain topographical features of an environment surrounding an infrastructure sensor system may impact its associated data collection range.

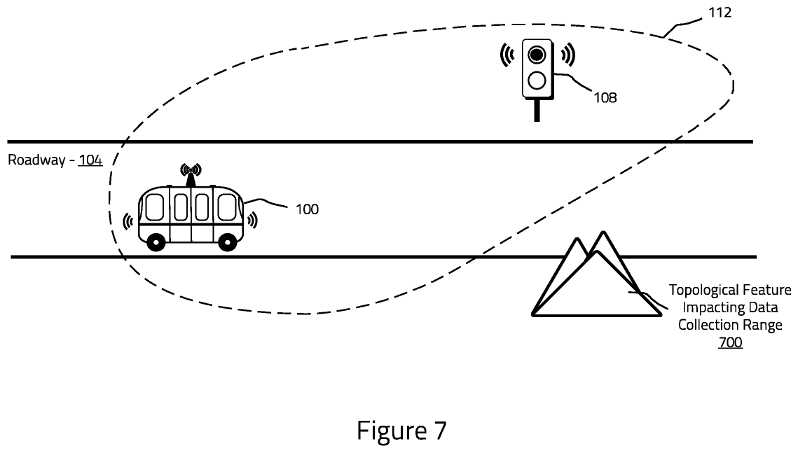

FIG. 7 illustrates a diagram showing a non-limiting example of determining a data collection range 112 of an infrastructure sensor system 108 consistent with certain embodiments of the present disclosure. As shown, topographical features 700 of the environment surrounding the infrastructure sensor system 108 (e.g., mountains in the illustrated example) may impact the data collection range of the infrastructure sensor system. In a further example, if a visibility sensor is placed in a valley between two ridges, a data collection range of the sensor system 108 may indicate that locations along the valley floor are “close” in the sense that the visibility conditions tend to be similar for the valley, whereas in a perpendicular direction towards the ridge, locations that are “close” in the Euclidean distance sense might be “far” in the sense that visibility conditions may change quickly when ascending the ridge upwards from the valley.

Sensor measurement data used in connection with various aspects of the disclosed embodiments may be collected using a variety of suitable techniques. In various embodiments, data may be accumulated in a continuous process whenever a vehicle is in operation in an area where suitable infrastructure sensor systems 108 are available. Such a continuous data accumulation process may involve, for example, a process that is ongoing continuously and data is stored during and/or shortly after a vehicle enters a data collection range of a sensor system, a process that is executed regularly on collected offline data, and/or combinations thereof. In further embodiments, the sensor measurement data may be collected “in one go” and/or may not necessarily be continuously collected and/or updated for refinement of the model.

In some embodiments, various aspects of the disclosed systems and methods may be implemented in a scenario where an AV drives along public roads during normal operation, which may provide relatively high-quality matches with real driving conditions, as well as where an AV is intentionally driven in a vicinity of a road infrastructure measurement device for the purpose of data collection, testing, model training, and/or model validation purposes. For example, in certain embodiments, an AV may be driven in along a test track where an infrastructure sensor is made available in a vicinity of a vehicle and recordings may be made from in-vehicle sensor systems and the infrastructure sensor system.

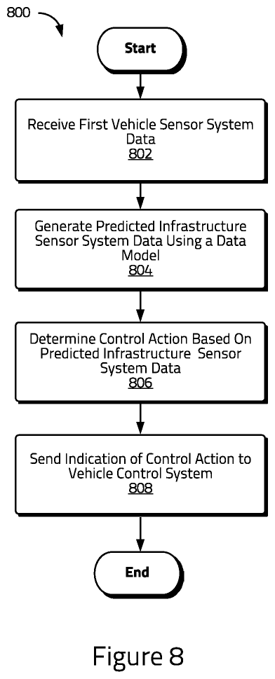

FIG. 8 illustrates a flow chart of a non-limiting example of a method 800 of operating a vehicle using a trained model consistent with certain aspects of the disclosed embodiments. The illustrated method 800 may be implemented in a variety of ways, including using software, firmware, hardware, and/or any combination thereof. In certain embodiments, various aspects of the method 800 and/or its constituent steps may be performed by a cloud service, a predictive model generation engine, network edge processing services, a vehicle system, and/or any other service and/or system and/or combinations of services and/or systems that may be used to implement various aspects of the disclosed systems and methods.

At 802, first vehicle sensor system data generated by a vehicle sensor system may be received. The vehicle sensor system data may comprise data of a variety of data types and/or be generated by a variety of vehicle sensor systems. For example and without limitation, the vehicle sensor system data may comprise data generated by one or more of a location sensor system, a speed sensor system, an accelerometer, a LIDAR sensor system, a vision sensor system (e.g., a camera), a RADAR sensor system, an environmental sensor system, and/or the like.

In some embodiments, the first vehicle sensor system data may be received directly from a vehicle sensor. For example, in some embodiments, a local vehicle system may perform certain aspects of the method 800 and may receive information directly from vehicle sensors and/or via one or more intermediate systems local to the vehicle. In further embodiments, the first vehicle sensor system data may be received by a system remote from the vehicle (e.g., a cloud service), and may be received via one or more intermediate communication systems and/or vehicle systems.

Predicted infrastructure sensor system data may be generated at 804 using a trained predictive infrastructure sensor system data model based on the received first vehicle sensor system data. In certain embodiments, predictive infrastructure sensor system data may be generated based on determining that actual infrastructure sensor system data is not available (e.g., by determining that a vehicle is outside a data collection range of an infrastructure sensor system and/or the like). In some embodiments, the first vehicle sensor system data may be provided as an input to the trained model, which may generate the predicted infrastructure sensor system data based on the provided input.

As discussed in detail above, the predictive infrastructure sensor system data model may be trained using time and/or location correlated actual infrastructure sensor system data generated by an infrastructure sensor system and vehicle sensor system data. Parameters of the model may be adjusted to reflect a correlative relationship between the correlated vehicle sensor system data and the infrastructure sensor system data generated by the infrastructure sensor system.

At 806, at least one control action may be determined and/or otherwise identified based on the predicted infrastructure sensor system data. The control action may comprise a variety of actions relating to the control and/or operation of the vehicle including, for example and without limitation, adjusting a vehicle speed, adjusting a vehicle acceleration, adjusting path of the vehicle, and/or the like. It will be appreciated that a variety of control actions may be implemented based on predicted infrastructure sensor system data consistent with various embodiments disclosed herein. An indication of the control action, which may comprise a control signal, may be communicated to an associated control system of the vehicle at 808.

In some embodiments, the infrastructure sensor system data model and/or associated predicted infrastructure sensor system data may be associated with a quality indication and/or value. Determining the at least one control action at 806 may be further based on the quality indication of the infrastructure sensor system data model and/or associated generated data. For example, the quality indication may be compared with at least one threshold (potentially a threshold associated with a particular control action). Based on this comparison, it may be determined whether the data is of sufficient quality and/or associated with sufficient predictive accuracy to be used in connection with vehicle control decisions. In some embodiments, data generated by the predictive model may be weighted based on the associated quality indication. For example, lower quality and/or weighted predicted data may be weighted less in a control action determination than higher quality and/or weighted predicted data. In further embodiments, certain actions with lower safety impacts may use lower quality and/or weighted predicted data than control actions with higher passenger safety impacts.

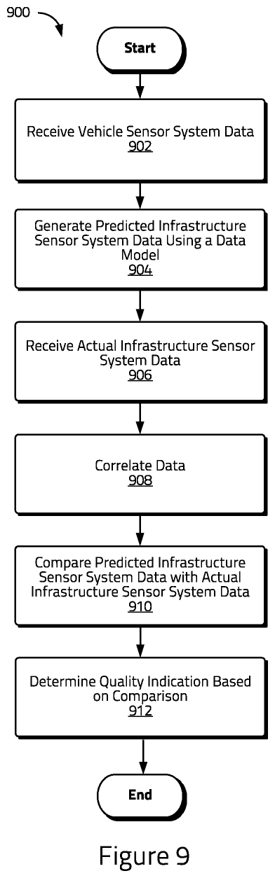

FIG. 9 illustrates a flow chart of a non-limiting example of a method 900 of validating a trained model consistent with certain aspects of the disclosed embodiments. The illustrated method 900 may be implemented in a variety of ways, including using software, firmware, hardware, and/or any combination thereof. In certain embodiments, various aspects of the method 900 and/or its constituent steps may be performed by a cloud service, a predictive model generation engine, network edge processing services, a vehicle system, and/or any other service and/or system and/or combinations of services and/or systems that may be used to implement various aspects of the disclosed systems and methods.

At 902, vehicle sensor system data generated by a vehicle sensor system may be received. The vehicle sensor system data may comprise data of a variety of data types and/or be generated by a variety of vehicle sensor systems. For example and without limitation, the vehicle sensor system data may comprise data generated by one or more of a location sensor system, a speed sensor system, an accelerometer, a LIDAR sensor system, a vision sensor system (e.g., a camera), a RADAR sensor system, an environmental sensor system, and/or the like.

In some embodiments, the vehicle sensor system data may be received directly from a vehicle sensor. For example, in some embodiments, a local vehicle system may perform certain aspects of the method 900 and may receive information directly from vehicle sensors and/or via one or more intermediate systems local to the vehicle. In further embodiments, the vehicle sensor system data may be received by a system remote from the vehicle (e.g., a cloud service), potentially via one or more intermediate communication systems and/or vehicle systems.

Predicted infrastructure sensor system data may be generated at 904 using a trained predictive infrastructure sensor system data model based on the received vehicle sensor system data. In some embodiments, the vehicle sensor system data may be provided as an input to the trained model, which may generate the predicted infrastructure sensor system data based on the provided input.

At 906, actual infrastructure sensor system data may be received from an infrastructure sensor system and/or an associated intermediate system. The actual infrastructure sensor system data may be correlated by time and/or location with the predicted infrastructure sensor system at 908. The correlated data may then be compared at 910. Based on the results of the comparison, the correlated data may be associated with a quality indication and/or a weight at 912 indicative of the predictive quality of the infrastructure sensor system data model.

It will be appreciated that a number of variations can be made to the architecture, relationships, methods, and examples presented in connection with FIGS. 1-9 within the scope of the inventive body of work. For example, certain illustrated and/or described processing steps may be performed by a single system and/or service and/or be distributed between multiple systems and/or services. Moreover, certain information processing workflows may be modified to include additional processing steps, eliminate certain processing steps, and/or reorder certain processing steps. Thus, it will be appreciated that the architecture, relationships, and examples presented in connection with FIGS. 1-9 are provided for purposes of illustration and explanation, and not limitation.

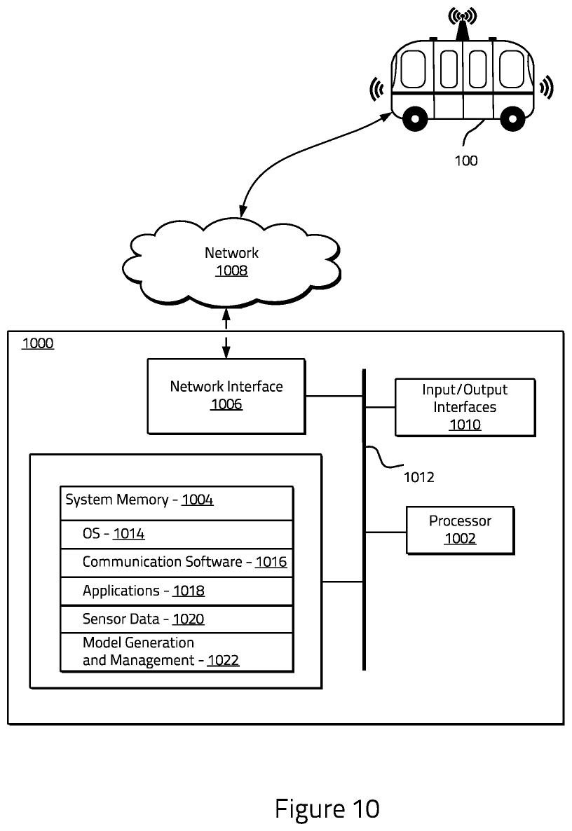

FIG. 10 illustrates an example of a system 1000 that may be used to implement certain embodiments of the systems and methods of the present disclosure. Certain elements associated with the illustrated system 1000 may be included in a system associated with and/or included in an AV 100, a cloud service, network edge services, an infrastructure sensor system, and/or any other system and/or service configured to implement aspects of the embodiments of the systems and methods disclosed herein.

As illustrated in FIG. 10, the system 1000 may include: a processing unit 1002; system memory 1004, which may include high speed random access memory (“RAM”), non-volatile memory (“ROM”), and/or one or more bulk non-volatile non-transitory computer-readable storage mediums (e.g., a hard disk, flash memory, etc.) for storing programs and other data for use and execution by the processing unit 1002; a port for interfacing with one removable memory that may include one or more diskettes, optical storage mediums, and/or other non-transitory computer-readable storage mediums (e.g., flash memory, thumb drives, USB dongles, compact discs, DVDs, solid state drives, etc.); a network interface 1006 for communicating with other systems (including systems associated with an AV 100) via one or more network connections 1008 using one or more communication technologies and/or channels; a user interface 1010 that may include a display and/or one or more input/output devices such as, for example, a touchscreen, a keyboard, a mouse, a track pad, and the like; and one or more buses 1012 for communicatively coupling the elements of the system.

The operation of the system 1000 may be generally controlled by the processing unit 1002 by executing software instructions and programs stored in the system memory and/or internal memory of the processing unit. The system memory 1004 may store a variety of executable programs or modules for controlling the operation of the system 1000. For example, the system memory 1004 may include an operating system (“OS”) 1014 that may manage and coordinate, at least in part, system hardware resources and provide for common services for execution of various applications, modules, and/or services.

The system memory 1004 may further comprise, for example and without limitation, communication software 1016 configured to enable in part communication with and by the system 1000; one or more applications 1018; sensor data 1020, which may comprise vehicle sensor system data, actual infrastructure sensor system data, and/or predicted infrastructure sensor system data, model generation and/or management engines and/or modules1022 configured to perform various functions of relating to model generation, management, and use, aspects thereof, and/or related functions and/or operations consistent with various aspects of the disclosed embodiments; and/or any other information and/or applications configured to implement embodiments of the systems and methods disclosed herein.

The systems and methods disclosed herein are not limited to any specific computer, device, service, or other apparatus architecture and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network.

Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, an optical storage medium, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein but may be modified with the scope and equivalents of the appended claims.

What is claimed is:

1. A method for managing the operation of a vehicle performed by a system comprising a processor and a computer-readable storage medium storing instructions that, when executed by the processor, cause the system to perform the method, the method comprising:
receiving first vehicle sensor system data generated by a vehicle sensor system;
generating predicted infrastructure sensor system data using an infrastructure sensor system data model, wherein generating the predicted infrastructure sensor system data comprises providing the first vehicle sensor system data as an input to the infrastructure system model;
determining at least one control action based on the predicted infrastructure sensor system data; and
sending to a control system associated with the vehicle an indication of the control action.

2. The method of claim 1, wherein the method further comprises:
determining that the vehicle is not within a data collection range of an infrastructure sensor system.

3. The method of claim 1, wherein the infrastructure sensor system data model is associated with a quality indication and wherein determining the at least one control action is further based on the quality indication of the infrastructure sensor system data model.

4. The method of claim 3, wherein the method further comprises comparing the quality indication with at least one threshold.

5. The method of claim 3, wherein the method comprises associating a weight to the predicted infrastructure sensor system data based on the quality indication.

6. The method of claim 5, wherein determining the at least one control action is further based on the weight associated with the predicted infrastructure sensor system data.

7. The method of claim 1, wherein the method further comprises training the infrastructure sensor system data model.

8. The method of claim 7, wherein training the infrastructure sensor system data model comprises:
receiving actual infrastructure sensor system data generated by an infrastructure sensor system; and
receiving second vehicle sensor system data generated by the vehicle sensor system.

9. The method of claim 8, wherein training the infrastructure sensor system data model further comprises correlating the actual infrastructure sensor data and the second vehicle sensor data.

10. The method of claim 9, wherein correlating the actual infrastructure sensor data and the second vehicle sensor data comprises correlating the actual infrastructure sensor data and the second vehicle sensor data by at least one of time and location.

11. The method of claim 9, wherein training the infrastructure sensor system data model comprising comprises adjusting at least one parameter of the infrastructure sensor system data model to reflect a correlative relationship between the second vehicle sensor system data and the actual infrastructure sensor system data.

12. The method of claim 1, wherein the method further comprises determining a quality indication associated with the infrastructure sensor system data model.

13. The method of claim 12, wherein determining the quality indication comprises receiving actual infrastructure sensor system data generated by an infrastructure sensor system.

13. The method of claim 13, wherein determining the quality indication further comprises comparing the actual infrastructure sensor system data generated by the infrastructure sensor system with the predicted infrastructure sensor system data generated using the infrastructure sensor system data model.

14. The method of claim 13, wherein the quality indication is based on the comparison of the actual infrastructure sensor system data with the predicted infrastructure sensor system data.

15. The method of claim 14, wherein the method further comprises associating a weight to the infrastructure sensor system data model based on the quality indication.

16. The method of claim 1, wherein the system comprises a vehicle system.

17. The method of claim 1, wherein the system comprises a system remote from the vehicle.

18. Wherein vehicle sensor system comprises one or more of a location sensor system, a speed sensor system, an accelerometer, a LIDAR sensor system, a vision sensor system, a RADAR sensor system, and an environmental sensor system.

19. Wherein infrastructure sensor system comprises one or more a location sensor system, a speed sensor system, a LIDAR sensor system, a vision sensor system, a RADAR sensor system, and an environmental sensor system.

20. Wherein vehicle comprises one or more of a fully autonomous vehicle, a semi-autonomous vehicle, and vehicle with a driver-assistance system.
